(19) United States
(12) Patent Application Publication
(10) Pub. No.: US 2025/0049075 A1
(43) Pub. Date: Feb. 13, 2025

(54) COMPOSITION COMPRISING TEXTURED FUNGAL PROTEIN PIECES

(71) Applicant: The Protein Brewery B.V., Breda (NL)

(72) Inventors: Maloe Kleine Haar, Breda (NL); Olumuyiwa Adetokunbo Akintoye, Breda (NL)

(73) Assignee: The Protein Brewery B.V., Breda (NL)

(21) Appl. No.: 18/719,270

(22) PCT Filed: Dec. 23, 2022
(86) PCT No.: PCT/EP2022/087797

§ 371 Date: Jun. 13, 2024

(30) Foreign Application Priority Data
Dec. 23, 2021 (EP) 21217577.2
Oct. 18, 2022 (EP) 22202146.1

(51) Int. Cl. A23J 3/22; A23J 3/20; A23L 29/256; A23L 31/00

(52) U.S. Cl. CPC A23J 3/227; A23J 3/20; A23L 29/256; A23L 31/00

(57) ABSTRACT

The present invention relates to a composition comprising at least 60 wt. % of textured fungal protein (TFP) pieces containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
   wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.

The TFP pieces in the present composition comprise fungal biomass providing protein, dietary fibre and fat. They can suitably be applied in food products, not only as a valuable source of protein and dietary fibre, but also to provide a desirable ‘chewy/fibrous’ texture.

### TECHNICAL FIELD OF THE INVENTION

The present invention relates to a composition comprising textured fungal protein pieces that contain 25 to 70 wt. % protein, and wherein at least 50 wt. % of the protein is fungal protein.

This composition of the present invention may suitably be applied in food products, such as meat analogues, as a valuable source of protein and dietary fibre, and also to provide a desirable ‘chewy/fibrous’ texture.

### BACKGROUND OF THE INVENTION

Demand for edible products that can provide a high protein content which is drawn from a non-animal source is increasing. Driven by increasing awareness of personal health, edible products that include non-animal sourced components such as proteins and fibers are considered as a healthier alternative to animal protein based products. In particular, there is growing demand for edible meat substitutes that mimic meat in its composition and texture but are composed of non-animal components, which can reduce reliance animals such as cows, and reduce the carbon footprint posed by such animals.

Single-cell proteins (SCP) are an interesting alternative to meat proteins and as protein source in many other food applications such as breakfast cereals, bread, pasta, dairy, ice cream, chocolate, and soups. When fungal SCP is produced, it can be produced from sugar rich crops in a more sustainable way as compared to the production of meat protein, because SCP yields many more tonnes of protein per hectare compared to meat production and has lower nitrogen emission.

One method for producing a dietary source of protein for human food or animal feed is to produce “single cell protein” (SCP) by means of fermentation (Suman et al., 2015, Int J. Curr. Microbiol. Appl. Sci., Vol 4., No 9., pp 251-262). Fermentation in this respect is understood as the microbial conversion of carbon-rich feedstocks into protein-rich products consisting of microbial cells such as bacteria, yeasts or fungi. The use of SCP as animal feed and food ingredient brings the further advantages that microbial cells have a high content of essential amino acids. Furthermore, in particular fungal cells can be very rich in trace elements and vitamins making the fermented feedstuffs very nutritive.

SCP is already used in food products for human consumption. For instance, Quorn™ comprises a mycoprotein produced as SCP by fermentation of the fungus Fusarium venenatum. Quorn™ is available in a variety of forms such as sausages, cutlets, burgers, patties, and strips.

Fermentative production of fungal biomass typically yields a fermentation broth having dry matter content of around 5 wt. %. This fermentation broth needs to be concentrated and optionally dried in order to render it suitable for application in food products. Concentrated or dried fungal biomass can suitably be applied in food products to provide valuable protein and dietary fibre. However, unlike textured vegetable protein (TVP), it does not impart significant texture.

A meat analogue is a meat-like substance that does not contain meat. Other common terms are plant-based meat, vegan meat, meat substitute, meat alternative and imitation meat. The main component of most commercially available meat analogues is a protein isolate from plants (soy protein, gluten, pea protein, faba bean protein), cow's milk (casein) or fungi (mycoprotein).

U.S. Pat. No. 4,423,083 describes a process for preparing white, bland-tasting protein fiber bundles which are texturally and nutritionally similar to the meat flesh of mammals, poultry or seafood, said process comprising the steps of:
(a) preparing a mixture comprising heat coaguable protein which is water-soluble or partially water-soluble, a water-soluble alginate and water;
(b) cooling the mixture to unidirectionally freeze the water into elongated ice crystals and to separate the protein into well-defined, well-ordered, substantially independent fibers;
(c) slicing the solid mass of step (b) in a direction parallel to the longitudinal axis of the ice crystal formation to form fiber bundles, each slice having a predetermined thickness
(d) melting the ice crystals;
(e) gelling, via infusion of gelation ions, the water-soluble alginate in each fiber bundle to reinforce the well-defined, well-ordered, fiber-like structure wherein the rate of gelling the water-soluble alginate is at the same speed as the melting rate of ice crystals in the fiber bundles and wherein the thickness of each slice permits ion infusion into the solid mass such that the rate of gelling is at the same speed as the rate of melting;
(f) heating the resulting fiber bundles to coagulate the protein;
(g) treating the coagulated protein fiber bundles with an aqueous solution of a sequestering agent for texture modification and to extract undesirable salts contributing off-flavors; and
(h) separating the white, bland-tasting protein fiber bundles from the bath containing the sequestering agent.

U.S. Pat. No. 5,626,899 describes a process for making a protein crumble comprising the steps of:
(a) chopping and blending one part soy protein isolate or soy protein concentrate with 3.5 to 5.0 parts water at ambient room temperature for a period of time adequate to hydrate said soy protein isolate;
(b) adding to the blend of step (a) a food ingredient combination including at least one powdered food ingredient taken from a group consisting of a vegetable protein and a complex carbohydrate;
(c) chopping material produced in step (b) for an additional period, the additional period being adequate to form a viscous gel materials, wherein a total chopping time for step a and c being in the range of about 3 to 7 minutes;
(d) cooling said viscous gel material of step (c) for enhancement of a textural integrity of the gel in step (c);
(e) separating said viscous gel material cooled in step (d) into discrete protein crumbles having a textural characteristic for use as a fat replacer or meat extender.

WO 03/061400 describes a method for the preparation of a meat substitute product which comprises protein, wherein:
1) a protein material, a hydrocolloid which precipitates with metal cations and water are added to one another,
2) the composition from step 1) is formed into a homogenous mixture,
3) the mixture from 2) is mixed with a solution of a metal cation with a valency of at least 2, in order to form a fibrous product,
4) the fibrous product is isolated, characterized in that
5) the protein material comprises a milk protein material, and
6) the mixture of milk protein material, hydrocolloid which precipitates with metal cations and water is formed in the presence of an amount of a phosphate material.

WO 2018/029353 describes a process for producing single cell protein (SCP), the process comprising the steps of:
a) growing a thermophilic fungus in a medium containing a fermentable carbon-rich feedstock; wherein the fungus is grown in submerged culture under non-sterile conditions at a temperature higher than 45° C. and a pH of less than 3.8; and,
b) recovery of SCP from the medium in the form of biomass of the thermophilic fungus grown in step a).

US 2020/0093155 describes a method for producing a food ingredient comprising the steps of:
a. culturing filamentous fungi in growth medium;
b. harvesting filamentous fungal biomass;
c. optionally, processing the harvested filamentous fungal biomass;
d. sizing the biomass to form particles; and
e. drying the particles to form the food ingredient.

GB-A 2 596 121 describes a foodstuff comprising potato protein and a second protein ingredient. Examples 19-21 describe vegan nuggets containing mycoprotein paste and sodium alginate.

### SUMMARY OF THE INVENTION

The present inventors have developed a composition comprising textured fungal protein (TFP) pieces comprising fungal biomass providing protein, dietary fibre and fat. The TFP pieces of the present invention offer the advantage that they can suitably be applied in food products, not only as a valuable source of protein and dietary fibre, but also to provide a desirable ‘chewy/fibrous’ texture.

The composition of the present invention comprises at least 60 wt. % of textured fungal protein (TFP) pieces, said TFP pieces having a dry weight of 20 to 1,500 mg and containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
   wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.

Compared to the protein isolates that form the basis of most commercial meat analogues, fungal biomass offers the advantage that it has the lowest ecological footprint, i.e. the lowest number of square metres needed for the production of 1 kg of protein. Furthermore, unlike the production of these protein isolates, the production does not contain any isolation steps. Finally, fungal biomass is not only rich in highly nutritious protein, but it also contains a high amount of dietary fibre in the form of chitin, chitosan, polyglucuronic acid and/or beta-glucans.

The inventors have found that the cross-linked anionic polysaccharide that is employed in accordance with the present invention is capable of forming a strong matrix around particles of fungal biomass, thus holding together these biomass particles within the TFP pieces, whilst at the same time providing these TFP pieces with a desirable ‘chewy/fibrous’ texture. The TFP pieces of the present invention offer the advantage that they can be processed and incorporated into other food products without falling apart when subjected to (low) shear.

Furthermore, the TFP pieces remain intact even when they are heated to high temperatures, e.g. when food products containing the TFP pieces are cooked to prepare them for consumption. The TFP pieces of the present invention have a pleasant firm, elastic texture which is believed to be associated with the high aminopolysaccharide content of the TFP pieces.

The invention also provides a process of preparing the aforementioned composition comprising TFP pieces, said process comprising:
providing a biomass dough comprising 50-99.7 wt. % fungal biomass by weight of dry matter, 0.5-20 wt. % anionic polysaccharide by weight of dry matter and 70-90 wt. % water, said anionic polysaccharide being selected from alginate, pectin and combinations thereof and being present in non-cross-linked form;
contacting pieces of the dough with an aqueous solution of divalent metal cation selected from Ca²⁺, Mg²⁺ and combinations thereof to cross-link the anionic polysaccharide within the dough and to thereby produce TFP pieces.

Also provided are a food product comprising 20-95 wt. % of the TFP pieces of the present invention a method of preparing such a food product.

### DETAILED DESCRIPTION OF THE INVENTION

Accordingly, a first aspect of the invention relates to a composition comprising at least 60 wt. % of textured fungal protein (TFP) pieces, said TFP pieces having a dry weight of 20 to 1,500 mg and containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
   wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.

The term “protein” as used herein refers to molecules comprising a chain of at least 20 amino acids.

The term “dietary fibre” as used herein refers to polysaccharides that are not digested by human digestive enzymes. Chitin and chitosan are examples of dietary fibres.

The term “polysaccharide” as used herein refers to a polymer comprising a long, optionally branched chain of monosaccharides, the total number of monosaccharides in the polysaccharide being at least 10.

The term “fat” as used herein refers to lipids containing one or more fatty acid residues. The terms “fat” and “oil” as used herein, unless indicated otherwise, should be considered synonyms.

The term “fungal biomass” as used herein refers to organic matter that originates from fungi. The term “a” or “an” as used herein is defined as “at least one” unless specified otherwise.

The term “or” as used herein is defined as “and/or” unless specified otherwise.

Unless indicated otherwise, all percentages mentioned herein should be construed as percentages by weight.

Besides TFP pieces having a dry weight of 20 to 1,500 mg, the composition of the present invention may contain pieces textured fungal protein having a dry weight outside the range of 20-1,500 mg. The composition may also suitably contain ingredients of non-fungal origin, such as minerals, vegetable protein, vegetable oil, marine oil, vitamins and combinations thereof.

Preferably, the present composition contains at least 80 wt. % of the TFP pieces, more preferably at least 90 wt. % of the TFP pieces.

The composition of the present invention preferably comprises at least 60 wt. % of TFP pieces having a dry weight of 30 to 1,200 mg, more preferably a dry weight of 40 to 1,000 mg.

The present composition preferably does not contain any meat or meat derived components. Preferably, the composition is a vegetarian composition, more preferably a vegan composition.

The TFP pieces preferably contain, calculated by weight of dry matter, 26-65 wt. % of protein, more preferably 28-60 wt. % of protein, more preferably 30-55 wt. % of protein and most preferably 40-50 wt. % of protein.

Besides fungal protein, the TFP pieces may contain other proteins such as gluten, legume protein or combinations thereof. Examples of legume proteins that may be used are soybean protein, pea protein, bean protein, lupin protein, lentil protein and combinations thereof.

Preferably at least 75 wt. % of the protein in the TFP pieces is fungal protein. More preferably, at least 85 wt. % of the protein in the TFP pieces is fungal protein. Most preferably, at least 95 wt. % of the protein in the TFP pieces is fungal protein.

The dietary fibre is preferably contained in the TFP pieces in a concentration, calculated by weight of dry matter, of 35-42 wt. %, more preferably of 30-40 wt. %.

Preferably, at least 10 wt. %, more preferably at least 12 wt. % and most preferably 14-30 wt. % of the dry matter in the TFP pieces is aminopolysaccharide selected from chitin, chitosan and combinations.

Chitin preferably constitutes 5-20 wt. %, more preferably 7-18 wt. %, most preferably 8-15 wt. % of the dry matter in the TFP pieces.

Chitosan preferably constitutes 5-20 wt. %, more preferably 7-18 wt. %, most preferably 8-15 wt. % of the dry matter in the TFP pieces.

Preferably, at least 35 wt. %, more preferably 40-75 wt. % of the dietary fibre in the TFP pieces is aminopolysaccharide selected from chitin, chitosan and combinations.

Chitin preferably constitutes 15-35 wt. %, more preferably 20-33 wt. %, most preferably 25-32 wt. % of the dietary fibre in the TFP pieces.

Chitosan preferably constitutes 15-35 wt. %, more preferably 20-32 wt. %, most preferably 24-31 wt. % of the dietary fibre in the TFP pieces.

Preferably, at least 30 wt. %, more preferably at least 40 wt. % and most preferably 45-70 wt. % of the carbohydrates in the TFP pieces is aminopolysaccharide selected from chitin, chitosan and combinations.

Chitin preferably constitutes 10-35 wt. %, more preferably 20-33 wt. %, most preferably 22-36 wt. % of the carbohydrates in the TFP pieces.

Chitosan preferably constitutes 10-35 wt. %, more preferably 20-32 wt. %, most preferably 21-34 wt. % of the carbohydrates in the TFP pieces.

The dietary fibre in the TFP pieces preferably contains 10-70 wt. %, more preferably 20-50 wt. % of polyglucuronic acid.

The combination of the aminopolysaccharide and polyglucuronic acid preferably constitutes at least 50 wt. %, more preferably at least 70 wt. % of the dietary fibre in the TFP pieces.

The TFP pieces of the present invention preferably contain, calculated by weight of dry matter, 0-15 wt. %, more preferably 0-10 wt. % and most preferably 0.5-5 wt. % of digestible carbohydrates.

The fat content of the TFP pieces, calculated by weight of dry matter, preferably is in the range of 6-20 wt. %, more preferably of 6.5-12 wt. %.

The anionic polysaccharide is preferably contained in the TFP pieces in a concentration, calculated by weight of dry matter, of 1-16 wt. %, more preferably of 2-12 wt. %.

The pectin employed in accordance with the present invention preferably is a low methoxy pectin.

According to a particularly preferred embodiment, the TFP pieces contain, calculated by weight of dry matter, at least 0.5 wt. % of alginate, more preferably 1-16 wt. % of alginate and most preferably 2-12 wt. % of alginate.

Preferably, the TFP pieces contain, per gram of dry matter, at least 0.5 mmol, more preferably 0.8-8 mmol and most preferably 1-7 mmol of divalent metal cation selected from Ca²⁺, Mg²⁺ and combinations thereof.

Preferably, the TFP pieces contain, per gram of anionic polysaccharide, at least 1 mmol, more preferably at least 2 mmol and most preferably 3-25 mmol of divalent metal cation selected from Ca²⁺, Mg²⁺ and combinations thereof.

In a preferred embodiment, the divalent metal cation that is employed in accordance with the present invention is Ca²⁺.

In an advantageous embodiment of the present invention, the divalent metal cation is introduced into the TFP pieces in the form of an acetate salt. Accordingly, in a preferred embodiment, the TFP pieces contain, per gram of anionic polysaccharide, at least 2 mmol acetate, more preferably 4-50 mmol acetate.

The TFP pieces of the present invention may suitably be prepared by intimately mixing particles of fungal biomass with non-gelling anionic polysaccharide, followed by ionic crosslinking of the anionic polysaccharide. Thus, the TFP pieces are preferably composed of fungal biomass particles that are held together by a matrix of cross-linked anionic polysaccharide. The fungal biomass particles preferably have a weight averaged mesh size of 50 to 400 μm, more preferably a weight averaged mesh size of 100 to 250 μm. The mesh size distribution of the fungal biomass particles can suitably be determined with a set of sieves of different mesh sizes.

The combination of fungal protein and the aminopolysaccharide preferably constitutes at least 40 wt. %, more preferably 50-70 wt. % of the dry matter that is contained in the TFP pieces.

The combination of protein, fat, dietary fibre and anionic polysaccharide preferably constitutes at least 70 wt. %, more preferably at least 75 wt. %, even more preferably 78-99.8 wt. % and most preferably 80-98 wt. % of the dry matter that is contained in the TFP pieces.

The present composition may be provided in hydrated, partially hydrated or dry form. Preferably the water content of the composition is in the range of 50 to 90 wt. %, more preferably in the range of 70 to 80 wt. %.

The TFP pieces in the present composition preferably have a water content of 50-90 wt. %, more preferably a water content of 70-80 wt. %.

According to a particularly preferred embodiment, the composition contains, calculated by weight of dry matter, 50-99.7 wt. % of fungal biomass, more preferably 70-99.5 wt. % of fungal biomass and most preferably 80-99 wt. % of fungal biomass.

In a particularly preferred embodiment of the present invention, the TFP pieces comprise biomass of a thermophilic fungus.

The TFP pieces of the present invention preferably comprise biomass of one or more fungi belonging to the class Zygomecetes. Zygomycetes exhibit a special structure of cell wall.

Most fungi have chitin as structural polysaccharide, while Zygomycetes also synthesize chitosan.

Preferably, the TFP pieces comprise biomass of a fungal strain of a fungal genus selected from the group consisting of Rasamsonia, Talaromyces, Penicillium, Acremonium, Humicola, Paecilomyces, Chaetomium, Rhizomucor, Rhizopus, Thermomyces, Myceliophthora, Thermoascus, Thielavia, Mucor, Stibella, Melanocarpus, Malbranchea, Dactylomyces, Canariomyces, Scytalidium, Myriococcum, Corynascus, and Coonemeria. more preferably the genus is Rhizomucor, more preferably the strain is a Rhizomucor pusillus, most preferably the strain is Rhizomucor pusillus CBS 143028, or a strain that is a single colony isolate or a derivative thereof.

The composition of the present invention may suitably be obtained by the preparation process that is described below.

Another aspect of the present invention relates to a process of preparing a composition as described herein before, said process comprising:
providing a biomass dough comprising 50-99.7 wt. % fungal biomass by weight of dry matter, 0.5-20 wt. % anionic polysaccharide by weight of dry matter and 70-90 wt. % water;
contacting pieces of the dough with an aqueous solution of divalent metal cation selected from Ca²⁺, Mg²⁺ and combinations thereof to cross-link the anionic polysaccharide within the pieces of dough.

The contacting of the pieces of dough with the aqueous solution of divalent metal cation may be carried out in different ways. In one embodiment of the present process, the biomass dough is chopped in the presence of the aqueous solution. In a particularly preferred embodiment, the biomass is chopped while the aqueous solution is added. During chopping pieces of biomass dough are formed and these pieces are fixated by the cross-linking action of the divalent metal cation.

In another embodiment of the present process, pieces of biomass dough are introduced into a bath of the aqueous solution of divalent metal cation. This may be achieved e.g. by dropping pieces of the biomass dough into the bath or by extruding the biomass dough into the bath. Again, the pieces of biomass become fixated by the cross-linking action of the divalent metal cation.

The biomass dough of the present process preferably comprises 60-99.5 wt. %, more preferably 80-99 wt. % of fungal biomass by weight of dry matter.

The biomass dough preferably contains, calculated by weight of dry matter 1-16 wt. %, more preferably 2-12 wt. % of anionic polysaccharide.

The water content of the biomass dough is preferably in the range of 72-85 wt. %, more preferably of 75-82 wt. %.

In a preferred embodiment, the process comprises the step of preparing the biomass dough by mixing wet biomass with the anionic polysaccharide, said anionic polysaccharide being selected from sodium alginate, potassium alginate and combinations thereof. The wet biomass is preferably prepared mixing 1 part by weight of dry biomass powder with 2 to 9 parts by weight of aqueous liquid, more preferably by mixing 1 part by weight of dry biomass powder with 3 to 5 parts by weight of aqueous liquid, said aqueous liquid having a water content of at least 90 wt. %.

In another preferred embodiment, the process comprises the step of preparing the biomass dough by mixing dry biomass powder with the anionic polysaccharide to produce a powder mix, said anionic polysaccharide being selected from sodium alginate, potassium alginate and combinations thereof, followed by mixing the powder mix with aqueous liquid. Preferably 1 part by weight of the powder mix is mixed with 2 to 9 parts by weight of the aqueous liquid. More preferably 1 part by weight of the powder mix is mixed with 1 to 4 parts by weight of the aqueous liquid. The aqueous liquid preferably has a water content of at least 90 wt. %.

Preferably, the process comprises the step of preparing an aqueous solution of divalent metal cation by mixing one or more calcium salts selected from calcium acetate, calcium gluconate and calcium chloride with aqueous liquid to provide 200-3,500 mmol/L of Ca²⁺, more preferably to provide 400-2,000 mmol/L of Ca²⁺.

It was found that calcium acetate is a particularly suitable source of calcium ions as the TFP pieces produced with this calcium salt had a very pleasant neutral taste. Accordingly, the aqueous solution of divalent metal cation is preferably preparing using calcium acetate as the calcium salt.

The fungal biomass that is employed in the present process preferably comprises biomass of a thermophilic fungus.

According to a particularly preferred embodiment, the fungal biomass used in the present process comprises biomass of a fungal strain of a fungal genus selected from the group consisting of Rasamsonia, Talaromyces, Penicillium, Acremonium, Humicola, Paecilomyces, Chaetomium, Rhizomucor, Rhizopus, Thermomyces, Myceliophthora, Thermoascus, Thielavia, Mucor, Stibella, Melanocarpus, Malbranchea, Dactylomyces, Canariomyces, Scytalidium, Myriococcum, Corynascus, and Coonemeria. more preferably the genus is Rhizomucor, more preferably the strain is a Rhizomucor pusillus, most preferably the strain is Rhizomucor pusillus CBS 143028, or a strain that is a single colony isolate or a derivative thereof.

The protein content of the fungal biomass, calculated by weight of dry matter, is preferably in the range of 25-65 wt. %, more preferably in the range of 28-60 wt. %, even more preferably in the range of 2-55 wt. % and most preferably in the range of 35-50 wt. %.

The dietary fibre content of the fungal biomass, calculated by weight of dry matter, preferably is in the range of 20-50 wt. %, more preferably of 25-45 wt. %, most preferably of 28-40 wt. %.

Preferably, at least 35 wt. %, more preferably 40-75 wt. % of the dietary fibre in the fungal biomass is aminopolysaccharide selected from chitin, chitosan and combinations.

Chitin preferably constitutes 15-35 wt. %, more preferably 20-33 wt. %, most preferably 25-33 wt. % of the dietary fibre in the fungal biomass.

Chitosan preferably constitutes 15-35 wt. %, more preferably 20-32 wt. %, most preferably 24-31 wt. % of the dietary fibre in the fungal biomass.

The dietary fibre in the fungal biomass preferably contains 10-70 wt. %, more preferably 20-50 wt. % of polyglucuronic acid.

The combination of the aminopolysaccharide and beta-glucan preferably constitutes at least 50 wt. %, more preferably at least 70 wt. % of the dietary fibre in the fungal biomass.

The fungal biomass of the present invention preferably contains 0-15 wt. %, more preferably 0-10 wt. % and most preferably 0.5-5 wt. % of digestible carbohydrates.

The fat content of the fungal biomass, calculated by weight of dry matter, preferably is in the range of 6-20 wt. %, more preferably of 6.5-12 wt. %.

A further embodiment of the present invention relates to a food product comprising at least 1 wt. %, more preferably 10-95 wt. %, most preferably 30-90 wt. % of the TFP pieces as described herein before.

According to a particularly preferred embodiment, the food product is a vegetarian food product, more preferably a vegan food product.

The food product of the present invention is preferably selected from meat analogues, food products containing pieces of meat analogue, meat products, soups, sauces, cereal-based food products and pet food. Most preferably the food product is a meat analogue or a food product containing pieces of meat analogues (e.g. a food product containing minced meat analogue).

Yet another aspect of the present invention relates to a method of preparing a food product as described above, said method comprising combining the composition comprising TFP pieces of the present invention with one or more other edible ingredients.

The invention is further illustrated by the following non-limiting examples.

### EXAMPLES

### Example 1: Production of Rhizomucor pusillus Biomass in Cake or Powder Form

For preculture Rhizomucor pusillus strain CBS 143028 was inoculated in 200 ml of a defined mineral medium at pH 5.5 containing KCl 0.17 g/L, KH₂PO₄ 1.3 g/L, Na₂HPO₄ 0.4 g/L, citric acid 0.5 gr/L, MgSO₄·7aq 0.7 gr/L, FeSO₄·7aq 0.03 gr/L, CaCl₂·2aq 0.035 gr/L, ZnSO4.7aq 0.04 gr/L, MnCl₂·4aq 0.004, CuSO₄·5aq 0.0005 gr/L, CoCl₂·6aq 0.0005 gr/L, Na₂B₄O₇·10aq 0.003 gr/L, KI 0.0003 gr/L, Na₂MoO₄·2aq 0.0005 gr/L, 11 g Dextrose per L; 4 g (NH₄)₂SO₄ per L; and 7.5 g tartaric acid per L. The preculture was incubated for 24 hours at 46° C., in a 1 L Erlenmeyer flask with air permeable stop with baffles, in an orbital shaker at 200 rpm. The preculture was then used to inoculate a fermenter containing the defined mineral medium as described above at a pH of 3.5 and comprising 77 g Dextrose per L as C-source; 1.4 g (NH₄)₂SO₄ per L as N-source and supplemented with NH₃ as titrant. The fungus was grown in the fermenter in fed batch mode at a doubling time of 12 hours. Olive oil was continuously being fed to maintain a concentration of 50 ppm.

Fermentation broths, having reached a dry matter content ranging from 2 to 5 weight percent, were concentrated using a vibrating sieve to achieve a minimum of 10% (w/w) dry matter. The biomass is then mixed with anti-oxidant and pasteurized.

Next the sieved biomass was compressed with a hydraulic press to obtain the Rhizomucor pusillus biomass as a cake with a dry matter content of about 29% (w/w). Part of the biomass cake was further freeze dried and milled (6000 rpm 1 mm mesh size) to obtain the Rhizomucor pusillus biomass in powder form with a dry matter content of about 96% (w/w).

The compositions of the Rhizomucor pusillus biomass in cake form and powder form were analysed. The results are shown in Tables 1-3.

TABLE 1

| Composition | Biomass in cake form | Biomass in powder form |
|---|---|---|
| Moisture | 71.1 g/100 g | 4 g/100 g |
| Ash | 1 g/100 g | 3.2 g/100 g |

TABLE 2

| | Rhizomucor pusillus | Rhizomucor pusillus |
|---|---|---|
| | biomass cake | biomass powder |
| Nutritional value | (29% dm) | (96% dm) |
| Crude protein content* | 14.3 g/100 g | 47.6 g/100 g |
| Total fat content | 2.4 g/100 g | 8.1 g/100 g |
| Total dietary fiber** | 10.6 g/100 g | 34.8 g/100 g |
| Total digestible | 0.8 g/100 g | 2.4 g/100 g |
| carbohydrates | | |
| Total sugars | <0.5 g/100 g | <0.5 g/100 g |
| Energy (kJoules) | 431 kJ/100 g | 1429 kJ/100 g |
| Energy (kcal) | 103 kcal/100 g | 341 kcal/100 g |

*Based on Kjeldahl method (N*6.25).
**Determination of the content of the total number dietary fiber method; enzymatic pre-treatment, gravimetry.

TABLE 3

| | Rhizomucor |
|---|---|
| | pusillus |
| | biomass cake |
| Amino acid profile | (29% dm) |
| Aspartic acid (+ Asparagine) | 1.04 g/100 g |
| Threonine* | 0.52 g/100 g |
| Serine | 0.52 g/100 g |
| Glutamic acid (+ Glutamine ) | 1.30 g/100 g |
| Proline | 0.39 g/100 g |
| Glycine | 0.48 g/100 g |
| Alanine | 0.63 g/100 g |
| Citrulline | >1 g/100 g |
| Valine* | 0.61 g/100 g |
| Isoleucine* | 0.52 g/100 g |
| Leucine* | 0.84 g/100 g |
| Tyrosine | 0.42 g/100 g |
| Phenylalanine* | 0.47 g/100 g |
| Lysine* | 0.80 g/100 g |
| Histidine* | 0.27 g/100 g |
| Arginine | 0.63 g/100 g |
| Cysteine | 0.12 g/100 g |
| Methionine* | 0.22 g/100 g |
| Tryptophan | 0.15 g/100 g |

*Essential amino acid for humans.

It must be taken into account that the protein content of the Rhizomucor pusillus biomass as shown in Table 2 is based on the Kjeldahl method, which is a standard method use to analyze the protein content of different food products. The Kjeldahl method is based on the total nitrogen content and uses a standard conversion factor of 6.25 to estimate the protein content in the analyzed food product. However, a conversion factor of 6.25 may not be appropriate for certain food products.

In the Rhizomucor pusillus biomass, the conversion factor may be overestimated due to the presence of other nitrogen sources such as RNA, chitin and chitosan. The real protein content of the Rhizomucor pusillus biomass can for this reason better be estimated through amino acid analysis. Typically, the real protein content of Rhizomucor pusillus biomass is around 30% by weight of dry matter.

### Example 2: Dietary Fibre Composition of the Rhizomucor pusillus Biomass

The dietary fibre content and composition of the Rhizomucor pusillus biomass was determined. The results are shown in Tables 4 and 5.

TABLE 4

| | DF | Moisture | % dry | DF |
|---|---|---|---|---|
| Dietary Fiber (DF) content | g/100 g | g/100 g | matter | % dm |
| Rhizomucor pusillus | 10.6 | 71.1 | 29 | 37 |
| biomass (cake) | | | | |

TABLE 5

| | Batch 1 | Batch 2 | Batch 3 | Batch 4 | Average | Unit |
|---|---|---|---|---|---|---|
| Chitin | 8.6 | 10.8 | 9.8 | 9.9 | 9.8 | g/100 g |
| Chitosan | 9.2 | 9.5 | 8.9 | 9 | 9.2 | g/100 g |

The dry matter-based dietary fiber content of the Rhizomucor pusillus biomass is extremely high. Interestingly, the Rhizomucor pusillus biomass does not only contain chitin as fiber but contains an almost equal amount of the fiber chitosan. Chitosan is the de-acetylated form of chitin and health benefits have been described for chitosan in animals.

### Example 3: Preparation of TFP Pieces from Rhizomucor pusillus Biomass

Textured fungal protein pieces according to the present invention were prepared starting from Rhizomucor pusillus biomass in powder form.

The biomass powder was mixed with tap water at a ratio of 1:4 to form a thick paste. Next, sodium alginate was added in concentration of 2 wt. % and homogeneously mixed through the paste.

A 15% calcium acetate solution was gradually added to the paste while chopping the paste in the bowl of a kitchen mixer with a dual blade. In total 2 parts by weight of calcium acetate solution was added to 1 part by weight of the paste. During the chopping the paste was formed into small flake particles that became suspended in the calcium acetate solution. Calcium induced cross-linking of the alginate in the flake particles substantially increased the cohesiveness and firmness of these flake particles.

The textured fungal protein pieces were recovered by pouring the mix suspension onto a sieve. Washing with running mains water was used to remove residual calcium acetate.

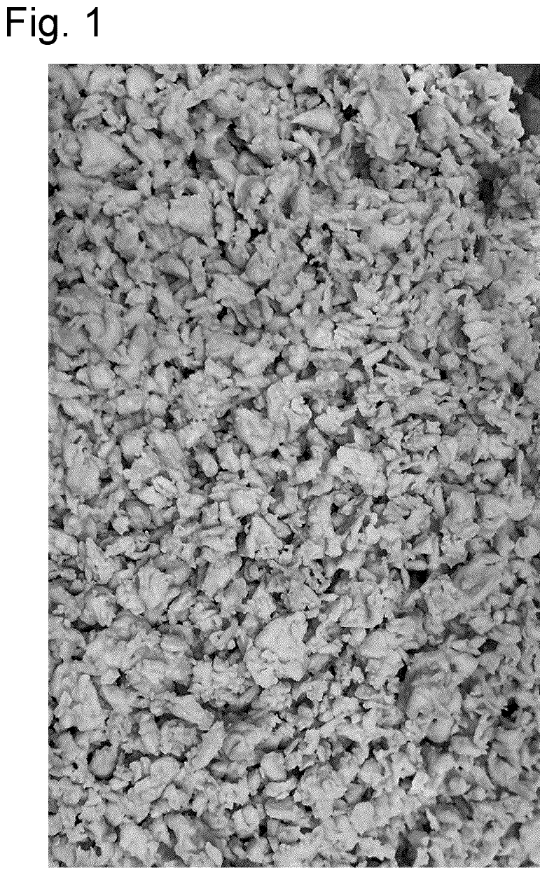

A photo of the TFP pieces so obtained is shown in FIG. 1.

### Example 4: Use of TFP Pieces from Rhizomucor pusillus Biomass in a Chicken Burger

A vegan chicken burger was prepared on the basis of the recipe that is shown in Table 6.

TABLE 6

| INGREDIENT | Wt. % |
|---|---|
| Water | 38 |
| TFP pieces of Example 3 | 40 |
| Dry Fermotein ® ¹ | 12 |
| Vital wheat gluten | 2 |
| Methocel MX ² | 5 |
| Flavour | 3 |
| TOTAL | 100 |

¹ Dried fungal biomass powder prepared as in Example 1
² Modified cellulose ex Dow Chemicals

All the ingredients were mixed together in a Kenwood mixer with a dough hook for 2-3 minutes until a coalesced ‘ball’ was formed.

The mass was left to rest for 15 minutes and then formed into a burger using a hand burger press. The burger was made to a weight of 100 gram. After resting, the burger was cooked in a live steam cabinet for 15 minutes at approximately 100° C. After cooking, the burger was placed in a chiller cabinet, and then sealed in a bag and frozen to −20° C. within 60 minutes.

The burger was then left in frozen storage for 2 weeks after which it was pan fried and evaluated by a small group of panellists. The product was described as having a firm cut, chewy and springy in the mouth, good bite but slightly gummy overall mouthfeel. The gummy mouthfeel may be reduced by lowering the modified cellulose content.

### Example 5: Preparation of TFP Pieces Using Biomass from Different Fungi

Textured fungal protein pieces were prepared in accordance with the procedure that is described in Example 3, using the biomass powders (appr. 8 wt. % moisture) from the following fungi:
Rhizomucor pusillus
Aspergillus niger
Trichoderma Reesei

The compositions of the different types of fungal biomass that were applied in the TFP pieces are shown in Table 7

TABLE 7

| | % (w/w) by weight of dry matter | | |
|---|---|---|---|
| | Rhizomucor | Aspergillus | Trichoderma |
| | pusillus | niger | Reesei |
| Protein | 30 | 13 | 45 |
| Fat | 8 | 2 | 4 |
| Carbohydrates | 35 | 80 | 23 |
| · Chitin/chitosan | 20 ¹ | 22 | 8 ² |

¹ Weight ratio chitin:chitosan was approximately 1:1
² Exclusively chitin

The recipe of the TFP pieces is shown in Table 8.

TABLE 8

| | Grams |
|---|---|
| Biomass | 25 |
| Sodium alginate | 2.5 |
| Calcium acetate solution (15%) | 250 |
| Water | 100 |

The TFP pieces produced from the three different types of biomass were subjected to compression tests and evaluated by an expert panel. The results of the compression tests (average of 3 measurements) are summarised in Table 9.

TABLE 9

| | Force (in N) | |
|---|---|---|
| | at 10% compression | at 50% compression |
| Rhizomucor pusillus | 0.7 | 9.3 |
| Aspergillus niger | 0.8 | 13.9 |
| Trichoderma Reesei | 0.3 | 2.7 |

The expert panel preferred the texture of the TFP pieces that had been produced from biomass of Rhizomucor pusillus. The sensory evaluation confirmed that the TFP pieces containing biomass of Trichoderma Reesei were softer than the TFP pieces containing other fungal biomass.

### Example 6: Comparison with GB-A 2 596 121

Nuggets were prepared on the basis of the recipe that is shown in Table 10, which corresponds to the recipe disclosed in Example 19 of GB-A 2 596 121, except that the mycoprotein paste of the British patent application was replaced by Rhizomucor pusillus biomass.

TABLE 10

| | Parts by |
|---|---|
| | weight |
| Rhizomucor pusillus biomass (25% dry matter) | 89.83 |
| Water | 1.5 |
| Natural flavour | 1.11 |
| Potato protein Solanic | 3.33 |
| Wheat gluten | 1.11 |
| Calcium acetate | 0.44 |
| Calium chloride liquid (36 wt % calcium chloride) | 1.17 |
| Carrageenan | 0.44 |
| Pea fibre | 0.97 |
| Sodium alginate | 1.09 |
| Total | 100.99 |

The nuggets were prepared following the procedure described in the British patent application.

Furthermore, TFP pieces were prepared in the same way as described in Example 3.

The nuggets prepared according to GB 2 596 121 and the TFP pieces according to the invention were evaluated blindly by an expert panel. Prior to presentation to the panel, the products were thawed and shallow fried.

The texture of the fried TFP pieces was clearly preferred over that of the fried nuggets. More particularly, the panel found that the TFP pieces were less dry and brittle and were more elastic than the nuggets.

The nuggets and TFP were subjected to compression tests, the results of which are summarised in Table 11.

TABLE 11

| | Force (in N) | |
|---|---|---|
| | at 10% compression | at 50% compression |
| Nuggets | 7.3 | Crumbled before 50% |
| | | compression was reached |
| TFP pieces | 0.7 | 9.3 |

### Example 7: Preparation of TFP Pieces for Use in Meat Burgers

TFP pieces designed for application in a meat burger were prepared in accordance with the procedure that is described in Example 3, on the basis of the recipe that is shown in Table 12.

TABLE 12

| | Parts by |
|---|---|
| | weight |
| Rhizomucor pusillus biomass (powder) | 19.14 |
| Water | 76.56 |
| Calcium diphosphate | 0.15 |
| Calcium chloride | 0.15 |
| Sodium alginate | 4.31 |
| Total | 100.31 |

### Example 8: Preparation of TFP Pieces and Application in Fish Burger

TFP pieces designed for application in a fish burger were prepared in accordance with the procedure that is described in Example 3, on the basis of the recipe that is shown in Table 13.

TABLE 13

| | Parts by |
|---|---|
| | weight |
| Rhizomucor pusillus biomass (powder) | 19.14 |
| Water | 76.56 |
| Calcium diphosphate | 0.08 |
| Calcium chloride | 0.08 |
| Sodium alginate | 4.31 |
| Total | 100.17 |

The TFP pieces so obtained were applied in fish burgers. The fish burgers were prepared on the basis of the recipe that is shown in Table 14.

TABLE 14

| | Wt. % |
|---|---|
| TFP pieces | 42.5 |
| Water | 34 |
| Rice flour | 10 |
| Rhizomucor pusillus biomass (powder) | 7 |
| Seasoning and flavouring | 4.4 |
| Methylcellulsoe (Methocel ® A4C) | 1.5 |
| Locust bean gum | 0.6 |

The fish burgers were prepared as follows:
Hydrate the methylcellulose and locust bean gum in water for 5 minutes.
In a food mixing bowl using a dough hook, add the TFP pieces, biomass powder, seasoning, flavouring and rice flour and mix;
Add the rehydrated methylcellulose and locust bean gum and mix until a dough is formed.
Weigh and mould burgers of 50 grams portions.
Coat the burgers with bread crumb
Bake the burgers in pan on medium heat for 3 minutes for each side.

1. A composition comprising at least 60 wt. % of textured fungal protein (TFP) pieces, said TFP pieces having a dry weight of 20 to 1,500 mg and containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
wherein the TFP pieces comprise biomass of one or more fungi belonging to the class Zygomycetes, wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.

2. Composition according to claim 1, wherein the combination of fungal protein and the aminopolysaccharide constitutes at least 40 wt. % of the dry matter that is contained in the TFP pieces.

3. Composition according to claim 1, wherein the combination of protein, fat, dietary fibre and anionic polysaccharide constitutes at least 70 wt. % of the dry matter that is contained in TFP pieces.

4. Composition according to claim 1, wherein the TFP pieces have a water content of 50-90 wt. %.

5. Composition according to claim 1, wherein 10-70 wt. % of the dietary fibe in the TFP pieces, more preferably 20-50 wt. % of the dietary fibre in the TFP pieces is polyglucuronic acid.

6. Composition according to claim 1, wherein the TFP pieces comprise biomass of a fungal strain of the genus is Rhizomucor.

7. Composition according to claim 1, wherein the anionic polysaccharide is alginate.

8. Composition according to claim 1, wherein the TFP pieces contain, per gram of anionic polysaccaride, at least 1 mmol, more preferably at least 2 mmol and most preferably 3-25 mmol of divalent metal cation selected from Ca²⁺, Mg²⁺ and combinations thereof.

9. Composition according to claim 1, wherein the TFP pieces are composed of fungal biomass particles that are held together by a matrix of cross-linked anionic polysaccharide.

10. A process of preparing a composition according to claim 1, said process comprising:
providing a biomass dough comprising 50-99.7 wt. % fungal biomass by weight of dry matter, 0.5-20 wt. % anionic polysaccharide by weight of dry matter and 70-90 wt. % water;
contacting pieces of the dough with an aqueous solution of divalent metal cation selected from Ca²⁺, Mg²⁺ and combinations thereof to cross-link the anionic polysaccharide within the pieces of dough.

11. Process according to claim 10, wherein the process comprises the step of preparing the biomass dough by mixing wet biomass with the anionic polysaccharide, said anionic polysaccharide being selected from sodium alginate, potassium alginate and combinations thereof.

12. Process according to claim 11, wherein the wet biomass is prepared mixing 1 part by weight of dry biomass powder with 2 to 9 parts by weight of aqueous liquid, said aqueous liquid having a water content of at least 90 wt. %.

13. A food product comprising at least 1 wt. %, preferably 10-95 wt. % of the TFP pieces having a dry weight of 20 to 1,500 mg and containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.

14. Food product according to claim 13, wherein the food is selected from meat analogues, food products containing pieces of meat analogue, meat products, soups, sauces, cereal-based food products and pet food.

15. A method of preparing a food product according to claim 13, said method comprising combining TFP pieces with one or more edible ingredients, said TFP pieces having a dry weight of 20 to 1,500 mg and containing, calculated by weight of dry matter:
25-70 wt. % of protein;
5-25 wt. % of fat;
20-45 wt. % of dietary fibre;
0.5-20 wt. % of anionic polysaccharide selected from alginate, pectin and combinations thereof;
wherein at least 50 wt. % of the protein is fungal protein, wherein at least 25 wt. % of the dietary fibre is aminopolysaccharide selected from chitin, chitosan and combinations thereof; and wherein the anionic polysaccharide is ionically cross-linked by divalent metal cation selected from Ca²⁺, Mg²⁺ and combinations thereof.
